(19) United States
(12) Patent Application Publication
(10) Pub. No.: US 2024/0403610 A1
(43) Pub. Date: Dec. 5, 2024

(54) SYSTEM, DEVICES AND/OR PROCESSES FOR APPLYING KERNEL COEFFICIENTS

(71) Applicant: Arm Limited, Cambridge (GB)

(72) Inventor: Maxim Novikov, Manchester (GB)

(21) Appl. No.: 18/329,425

(22) Filed: Jun. 5, 2023

(51) Int. Cl. G06N 3/0464

(52) U.S. Cl. CPC G06N 3/0464

(57) ABSTRACT

Example methods, apparatuses, and/or articles of manufacture are disclosed that may be implemented, in whole or in part, in techniques to apply convolution operations to values defined in a feature map. In one example implementation in which a resulting output is to be formatted in a higher resolution, interpolation operations may be interleaved with application of kernel coefficients in a convolution operation.

### BACKGROUND

### 1. Field

The present disclosure relates generally to systems, devices and/or techniques to process feature maps.

### 2. Information

Feature maps, such as image frames composed of image signal intensity values corresponding to pixel locations, may be processed using convolution operations. Such convolution operations typically comprise an application of kernel coefficients to features of a feature map to impart intended effects. In the particular application of convolutions to an image frame, such intended effects may comprise blurring, interpolating/demosaicing, sharpening, embossing, feature detection/extraction (e.g., edge detection), just to provide a few examples.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram of a system to apply convolution operations to a feature map, according to an embodiment;

FIGS. 2A, 2B and 2C are schematic diagrams of different segmentations of components and/or channels of a feature map, according to an embodiment;

FIGS. 3A, 3B and 3C diagrams illustrating a progression of application of kernel coefficients to components and/or channels of a feature map having different resolutions, according to an embodiment;

FIG. 4 is a flow diagram of a technique for processing image signal intensity values including applying a further convolution operation, according to an embodiment; and

FIG. 5 is a schematic diagram of a computing system, according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

As pointed out above, a feature map (e.g., image frame) may be processed by application of one or more convolution operations. Such convolution operations may comprise, for example, application of a kernel to features of a feature map (e.g., image signal intensity values associated with pixel locations of an image frame) to impart an intended effect. In this context, a “kernel” as referred to herein means a set of organized parameters of a convolution operation to be applied to one or more features of a feature map (e.g., image signal intensity values associated with pixel locations in an image frame, to impart a particular intended effect to the feature map). Such an intended effect to be imparted to an image may comprise, for example, blurring, interpolating/demosaicing, sharpening, embossing, feature detection/extraction (e.g., edge detection), just to provide a few examples. In a particular implementation, a kernel may comprise an ordered array of values (e.g., coefficients in an integer or floating-point format) tailored for application to feature values of a feature map of a particular dimensionality. Dimensions of such a feature map may correspond to color intensity values and/or pixel locations, for example. According to an embodiment, a convolution (e.g., filtering) operation for application of a kernel to feature values of a feature map may be implemented according to expression (1) as follows:

$$g ( x , y ) = ω * f ( x , y ) = {\sum }_{dx = - a}^{a} {\sum }_{dy = - b}^{b} ω ( dx , dy ) f [ ( x + dx ) , ( y + dy ) ] , \qquad ( 1 )$$

where:
   f(x,y) are feature values of a feature map at sample indices x,y;
   ω is an expression of a kernel defined over a range −a≤dx≤a and −b≤dy≤b; and
   g(x,y) are output sample values to be associated with sample indices x,y in an output feature map processed according to kernel ω.

While a as used in expression (1) is defined above for a symmetric range for −a≤dx≤a and −b≤dy≤b, in other implementations ω may defined for an asymmetric range such as, for example, 0≤dx≤a and 0≤dy≤b. Additionally, while expression (1) shows a convolution operation for a single input channel (e.g., single color channel), other convolution operations may be defined for multiple input channels (e.g., multiple color channels) and/or with different stride and/or groupings without deviating from claimed subject matter.

In particular implementations, convolution operations applied to feature maps such as to process image frames may consume substantial processing resources such as, for example, memory, power and processor resources. Such consumption of processing resources by convolution operations may particularly impact constrained processing resources of a small form factor, low power device.

In one application, feature maps in one resolution may be upscaled to a higher resolution to, for example, combine the upscaled feature map with another feature map at the higher resolution and/or generate a signal to an output device (e.g., display device). In an example implementation, generation of an upscaled feature map (e.g., upscaled image frame) may comprise interpolating image signal intensity values between and/or among neighboring image signal intensity values in a lower resolution feature map (e.g., lower resolution image frame). According to an embodiment an upscaled feature map may be conditioned and/or processed by application of one or more kernels in one or more convolution operations.

In particular implementations, an entirety of interpolated image signal intensity values of an upscaled image frame may be computed and stored as an intermediate result prior to a convolution operation, consuming substantial memory resources. According to an embodiment, application of a convolution operation to a feature map may comprise interpolating a first portion of features of the feature map to provide first interpolated portion and applying kernel coefficients to the first interpolated portion. Subsequent to commencement of application of the kernel coefficients to the first interpolated portion, a second portion of features of the feature map may be interpolated to provide a second interpolated portion. Kernel coefficients may then be applied to the second interpolated portion. Here, interpolation of features in less than an entirety of a feature map, interleaved with application of kernel coefficients to interpolated features between interpolation operation, may obviate a need to store an entirety of interpolated values for an upscaled feature map (e.g., to perform a convolution operation). Obviating such a need to store an entirety of interpolated values may reduce a processing burden on constrained processing resources.

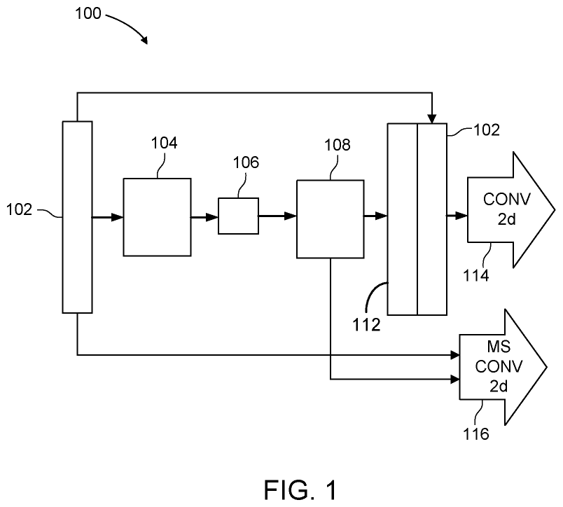

FIG. 1 is a schematic diagram of a system 100 to process a feature map according to an embodiment. Different components and/or channels of the feature map may be represented in different resolutions and/or granularities. In one embodiment, such a feature map may comprise an image frame defining one or more image signal intensity values at pixel locations in the image frame. In one particular implementation, components and/or feature maps 102, 104, 106, 108 and 112 may be expressed in different resolutions and/or granularities. For example, component and/or feature map 102 and component and/or feature map 112 may be expressed in respective formats having the same granularity and/or resolution. Components and/or feature maps 104, 106 and 108, on the other hand, may be expressed in respective formats having a lower resolution.

According to an embodiment, system 100 may combine multiple components and/or channels convolution operations to provide a processing result. For example, convolution operation 114 may apply kernel coefficients to components and/or feature maps 102 and 112 to produce a processing result. Since a format of component and/or feature map 102 may have the same resolution as a format of component and/or feature map 102, producing such a processing result may not entail any upscaling of component and/or feature map 102 or 112. In another embodiment, convolution operation 116 may apply kernel coefficients to components and/or feature maps 102 and 108 to provide a different processing result. Since a resolution of the format of component and/or feature map 108 may be less/coarser than a resolution of the format of component and/or feature map 108, component and/or feature map 108 may be upscaled to a resolution that matches the resolution of component and/or feature map 102. In one implementation, upscaling of component and/or feature map 108 to match a resolution of component and/or feature map 102 may entail an interpolation of features (e.g., image signal intensity values) between sample intervals (e.g., pixel locations) to provide an upscaled component and/or feature map. Other applications of such interpolation operations may be applied in U-Net and U-Net-like processing architectures with skipped connections. Storing results of an interpolation of features to provide an upscaled component and/or feature map may consume substantial memory resources, which may be limited in low power, small form factor and real-time implementations as discussed above. As discussed herein, formulating a computation as a cross-scale convolution rather than upscaling may impart benefit from a larger receptive field in some implementations.

According to an embodiment of a convolution operation, kernel coefficients are applied to features associated with a plurality of sample indices of a feature map to generate first output values mapped to sample indices in a second feature map format. In a particular implementation, a resolution of the sample indices in the second feature map format is greater than a resolution of the sample indices in the first feature map format. The convolution operation may comprise an interpolation of a first portion of feature values to provide a first interpolated portion, followed by application of at least some of the kernel coefficients to the first interpolated portion to provide a first convolved result. Subsequent to commencement of application of kernel coefficients to the first interpolated portion, a second portion of the features may be interpolated to provide a second interpolated portion corresponding to sample indices in the second feature map format. Kernel coefficients may then be applied to the second interpolated portion to provide a second convolved result. Here, application of a convolution to an interpolation of only a only a first portion of a feature map prior to interpolation of a second portion of the feature map may relieve requirements to store interpolated values for an entirety of the feature map (e.g., storage of an entirety of an upscaled feature map).

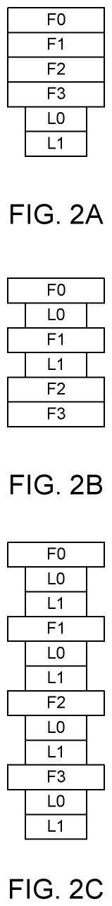

As pointed out above, convolution operation 116 may combine two components and/or channels of a feature map, components and/or channels 102 and 108. In other embodiments, a convolution operation may combine three or more components and/or channels of a feature map formatted with different resolutions and/or granularities. In the example implementations of FIGS. 2A, 2B and 2C, feature map components and/or channels F0, F1, F2, F3, L0 and L1 may be combined in a convolution operation. According to an embodiment, feature map components and/or channels F0, F1, F2 and F3 may be expressed in a full-resolution feature map format while feature map components and/or channels L0 and L1 may be expressed in a reduced or lower resolution feature map format.

FIGS. 2A, 2B and 2C illustrate different modes of convolution to combine feature map components and/or channels F0, F1, F2, F3, L0 and L1. FIG. 2A illustrates a normal mode in which feature map components and/or channels are convolved in a sequence F0, F1, F2, F3, L0 and L1. FIG. 2B illustrates an interleave mode in which convolution of components and/or channels expressed in a full-resolution feature map format is interleaved with convolution of components and/or channels expressed in a reduced or lower resolution feature map format. FIG. 2C illustrates a repeat-interleave mode in which components and/or channels L0 and L1 are convolved repeatedly in separate convolutions with respective components and/or channels F0, F1, F2 and F3.

According to an embodiment, a convolution operation may be applied to combine multiple feature map components and/or channels of a feature map having different resolutions to provide output feature values Out(B,Cₒᵤₜ,x,y) at sample indices x, y according to expression (2) as follows:

$$Out ( B , {C}_{out} , x , y ) = {\sum }_{ox = 0}^{K - 1} {\sum }_{oy = 0}^{K - 1} {\sum }_{k = 0}^{{C}_{in}} W ( {C}_{out} , k ) * \{ \begin{matrix}{X}_{full} ( B , {map}_{full} ( k ) , y + oy , x + ox ) & if k ∈ {map}_{full} \\ {X}_{reduced}^{int} ( B , {map}_{reduced} ( k ) , \frac{y \times {H}_{reduced}}{{H}_{full}} + & otherwise \\ oy , \frac{x \times {W}_{reduced}}{{W}_{full}} + ox ) & \end{matrix} \qquad ( 2 )$$

Where:
   X_{full} (B,map_{full}(k),y+oy,x+ox) is a feature value associated with sample indices y+oy,x+ox in a full-resolution component and/or channel of a feature map (e.g., F0, F1, F2 or F3) for a batch B; and

$${X}_{reduced}^{int} ( B , {map}_{reduced} ( k ) , \frac{y \times {H}_{reduced}}{{H}_{full}} + oy , \frac{x \times {W}_{reduced}}{{W}_{full}} + ox )$$

is an interpolated feature value at computed sample indices

$$\frac{y \times {H}_{reduced}}{{H}_{full}} + oy , \frac{x \times {W}_{reduced}}{{W}_{full}} + ox$$

in a reduced-resolution component and/or channel of a feature map (e.g., L0 or L1) for a batch B;
   W(Cₒᵤₜ,k) is a kernel defining coefficients to be applied to features of a component and/or channel k of a feature map to produce output feature values for an output channel Cₒᵤₜ;
   H_{full} is a scale of sample indices in a full-resolution component and/or channel of a feature map along a y-dimension;
   H_{reduced} is a scale of sample indices in a reduced-resolution component and/or channel of a feature map along an y-dimension;
   W_{full} is a scale of sample indices in a full-resolution component and/or channel of a feature map along an x-dimension; and
   W_{reduced} is a scale of sample indices in a reduced-resolution component and/or channel of a feature map along an x-dimension.
   map_{full}(k) parameters to select and/or control application of kernel coefficients to components and/or channels at a full resolution; and map_{reduced}(k) parameters to select and/or control application of kernel coefficients to components and/or channels at a reduced resolution.

While an operation according to expression (2) is defined above for an asymmetric range for 0≤ox≤K−1 and 0≤oy≤K−1, in other implementations such an operation may defined for a symmetric range such as, for example, −K≤ox≤K and −K≤oy≤K. Additionally, different variations of operations according to expression (2), such as differently grouped convolutions and/or with different stride without deviating from claimed subject matter.

According to an embodiment, interpolation operations to compute X_{reduced}^{int} may employ any one of multiple different interpolation techniques such as, for example nearest neighbor interpolation, bilinear interpolation or bicubic interpolation, just to provide a few examples.

In the particular implementation of expression (2), features (e.g., image signal intensity values) are associated with sample indices denoted as spatial indices (e.g., pixel locations), which are expressed in x and y coordinates. Output feature values Out(B,Cₒᵤₜ,x,y) for output channels 1, 2, . . . , Cₒᵤₜ at sample indices x,y (e.g., pixel locations) are computed based on input feature values X_{full} at

$$y + oy , x + ox and {X}_{reduced}^{int} at \frac{y \times {H}_{reduced}}{{H}_{full}} + oy , \\ \frac{x \times {W}_{reduced}}{{W}_{full}} + ox ( oy , ox ∈ 0 , … , K - 1 )$$

for input components and/or channels 1, 2, . . . , Cᵢₙ.

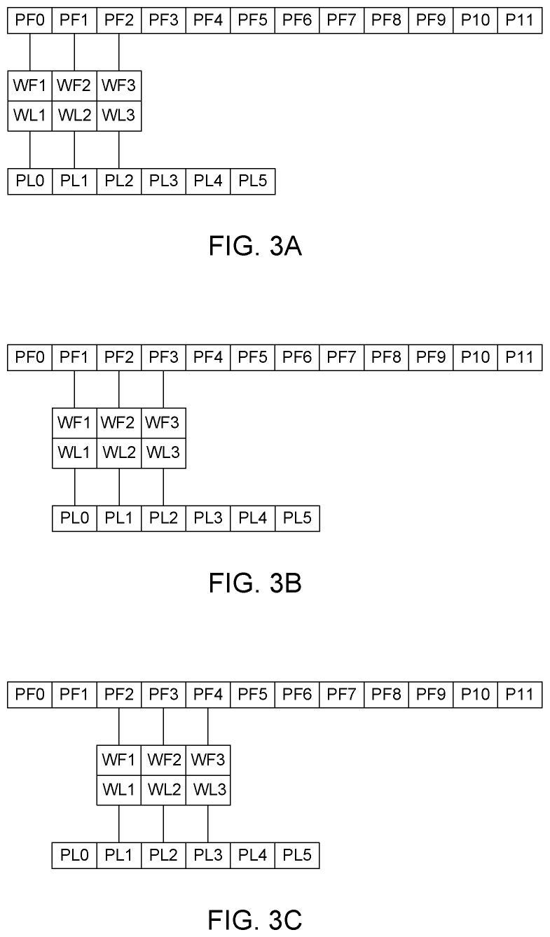

FIGS. 3A, 3B and 3C illustrate a progression of an application of kernel coefficients to features associated with sample indices in channels and/or components of a feature map, according to embodiments. For simplicity, the particular example of FIGS. 3A, 3B and 3C of illustrates a progression of application of kernel coefficients along sample indices in a single linear dimension. It should be understood, however, that application of kernel coefficients may similarly progress in two or more dimensions of a channel and/or component of a feature map, as well as for different kernel sizes, feature map sizes, kernel dilation, stride, just to provide a few examples of different parameters to define how a convolution operation may be applied.

According to an embodiment, kernel coefficients WF1, WF2 and WF3 are to be applied to features PF0 through PF11 expressed in a full-resolution channel and/or component. Also, kernel coefficients WL1, WL2 and WL3 are to be applied to features PL0 through PL4 expressed in a reduced resolution channel and/or component. In 3A, kernel coefficients WF1, WF2 and WF3 are applied to PF0 through PF11 and kernel coefficients WL1, WL2 and WL3 are applied to PL0 through PL4 to provide output feature values corresponding to the same first sample indices in an output feature map. Similarly in FIG. 3B, kernel coefficients WF1, WF2 and WF3 are applied to PF0 through PF11 and kernel coefficients WL1, WL2 and WL3 are applied to PL0 through PL4 to provide output feature values corresponding to the same second sample indices in an output feature map. Likewise in FIG. 3C, kernel coefficients WF1, WF2 and WF3 are applied to PF0 through PF11 and kernel coefficients WL1, WL2 and WL3 are applied to PL0 through PL4 to provide output feature values corresponding to the same third sample indices in an output feature map. Additionally, it should be noted that integer locations in an output feature map may not necessarily correspond to integer locations in lower-resolution feature map. In some implementations, interpolation may be applied prior to or after a multiply-accumulate operation. For example, in one implementation, a local portion of an image frame and/or feature map at a lower resolution may be interpolated to provide values at a higher resolution prior to application of kernel coefficients to provide an output value for an image frame and/or feature map at a higher resolution. In another implementation, kernel coefficients may be applied to values associated with sample indices in a lower resolution format to provide an output value associated with a sample index/indices in the lower resolution. Output values associated with sample indices in the lower resolution from multiple such convolutions may be interpolated to output values associated with sample indices in a higher resolution.

In one embodiment, first features of a first feature map may be convolved with a plurality of kernel coefficients, where the first features are associated with a first plurality of sample indices in a first feature map format. Convolution of the first features of the first feature map with the plurality of kernel coefficients may generate a plurality of first output values mapped to sample indices in the first feature map format. The first output values may then be interpolated to provide first interpolated values of a second feature map mapped to first sample indices in one or more second feature map formats. Subsequent to commencement of interpolation of the first output values to provide the first interpolated values, second features of the first feature map associated with a second plurality of sample indices in the first feature map format may be convolved with the kernel coefficients to generate a plurality of second output values mapped to sample indices in the first feature format. In one implementation, the first features of the first feature map may comprise image signal intensity values associated with first pixel locations of an image frame and the second features of the first feature map may comprise image signal intensity values associated with second pixel locations of the image frame. In another implementation, the second output values may be interpolated to second sample indices in the one or more second feature map formats.

According to an embodiment, a progression of operations of FIGS. 3A, 3B and 3C may account for differences in resolutions of input components and/or channels by varying a shift in how kernel coefficients WL1, WL2 and WL3 are to be applied to PL0 through PL4. Operations of FIG. 3A apply kernel coefficients WF1, WF2 and WF3 to PF0, PF1 and PF2, respectively, to produce a first output feature value at the first sample indices. Operations of FIG. 3B apply the same kernel coefficients WF1, WF2 and WF3 to shifted sample values PF1, PF2 and PF3, respectively, to produce a second output feature value at second sample indices. In FIGS. 3A and 3B, kernel coefficients WL1, WL2 and WL3 are to be applied to PL0, PL1 and PL2, respectively, to produce first and second output feature values at the respective first and second sample indices. In FIG. 3C, kernel coefficients WL1, WL2 and WL3 are to be applied to PL1, PL2 and PL3, respectively, to produce a third feature values at corresponding third sample indices.

In expression (2), execution advances for sample indices x,y incremented at intervals as ox and oy. For each computation increment ox,oy, kernel coefficients are applied to associated input feature values of an input component and/or channel 1, 2, . . . , Cᵢₙ for a particular iteration k∈1, 2, . . . , Cᵢₙ. For example, at each computation increment ox,oy, kernel coefficients W(Cₒᵤₜ,k) are to be applied to portions of all components and/or channels on iterations k E 1, 2, . . . , Cᵢₙ. In the embodiments of FIGS. 2A, 2B and 2C, for example, at each computation increment ox,oy, kernel coefficients W(Cₒᵤₜ,k) are to be applied to all components and/or channels F0, F1, F2, F3, L0 and L1 on corresponding iterations k E 1, 2, . . . , Cᵢₙ. If at a computation increment ox,oy, a component and/or channel of an iteration k is expressed in a full resolution feature map format (e.g., F0, F1, F2 or F3), no interpolation is to be applied and kernel coefficients W(Cₒᵤₜ,k) are applied to uninterpolated feature values X_{full} indexed by y+oy and x+ox. If at a computation increment ox,oy, a component and/or channel of an iteration k is expressed in a reduced resolution feature map format (e.g., L0 or L1), kernel coefficients W(Cₒᵤₜ,k) are to be applied to interpolated feature values X_{reduced}^{int} indexed by

$$\frac{y \times {H}_{reduced}}{{H}_{full}} + oy , \frac{x \times {W}_{reduced}}{{W}_{full}} + ox .$$

It should be understood, however, that this is merely one example of a coordinate mapping between scales that may be applied, and that other coordinate mappings may be applied without deviating from claimed subject matter.

As may be observed, once kernel coefficients have been applied to interpolated feature values X_{reduced}^{int} to compute corresponding values Out(B,Cₒᵤₜ,x,y) for particular sample indices x,y in a particular iteration k of a corresponding component and/or channel, such interpolated feature values X_{reduced}^{int} need not be stored for future computation of Out(B,Cₒᵤₜ,x,y) for other sample indices x,y (e.g., at a future iteration k of the corresponding component and/or channel).

According to an embodiment, parameters map_{full}(k) and map_{reduced}(k) may be used to select and/or control particular modes of convolution such as, for example, modes of convolution illustrated in FIGS. 2A, 2B and 2C. For a normal mode illustrated in FIG. 2A, for example, map_{full}(k) and map_{reduced}(k) may be set forth in arrays according to expression (3) as follows:

$${map}_{full} ( k ) = ( \begin{matrix}0 & 0 \\ 1 & 1 \\ ⋮ & ⋮ \\ {C}_{full} - 1 & {C}_{full} - 1\end{matrix} ) \qquad ( 3 )$$

$${map}_{reduced} ( k ) = ( \begin{matrix}{C}_{full} & 0 \\ {C}_{full} + 1 & 1 \\ ⋮ & ⋮ \\ {C}_{full} + {C}_{reduced} - 1 & {C}_{reduced} - 1\end{matrix} )$$

where:
   C_{full} is a count of full-resolution components and/or channels of input components and/or channels 1, 2, . . . , Cᵢₙ.; and
   C_{reduced} is a count of reduced-resolution components and/or channels of input components and/or channels 1, 2, . . . , Cᵢₙ.

For an interleave mode illustrated in FIG. 2B, for example, map_{full}(k) and map_{reduced} (k) may be set forth in arrays according to expression (4) as follows:

$${map}_{full} ( k ) = ( \begin{matrix}0 & 0 \\ 2 & 1 \\ ⋮ & ⋮ \\ 2 \times ( {C}_{full} - 1 ) & {C}_{full} - 1\end{matrix} ) \qquad ( 4 )$$

$${map}_{reduced} ( k ) = ( \begin{matrix}1 & 0 \\ 3 & 1 \\ ⋮ & ⋮ \\ 2 \times {C}_{reduced} - 1 & {C}_{reduced} - 1\end{matrix} ) .$$

For a repeat-interleave mode as illustrated in FIG. 2C, for example, map_{full}(k) and map_{reduced} (k) may be set forth in arrays according to expression (5) as follows:

$${map}_{full} ( k ) = ( \begin{matrix}0 & 0 \\ {C}_{reduced} & 1 \\ ⋮ & ⋮ \\ ( {C}_{full} - 1 ) \times ( {C}_{reduced} + 1 ) - 1 & {C}_{full} - 1\end{matrix} ) \qquad ( 5 )$$

$${map}_{reduced} ( k ) = ( \begin{matrix}( {C}_{reduced} + 1 ) \times N + 1 & 0 \\ ( {C}_{reduced} + 1 ) \times N + 2 & 1 \\ ⋮ & ⋮ \\ ( {C}_{reduced} + 1 ) \times N + {C}_{reduced} & {C}_{reduced} - 1\end{matrix} ) .$$

It should be understood that expressions (3) through (5) are merely examples of mappings to define parameters in expression (2) to control modes of convolution, and that other variants may be used without deviating from claimed subject matter. While specific examples are illustrated for two scales, similar principles may be applied for additional scales and/or inputs.

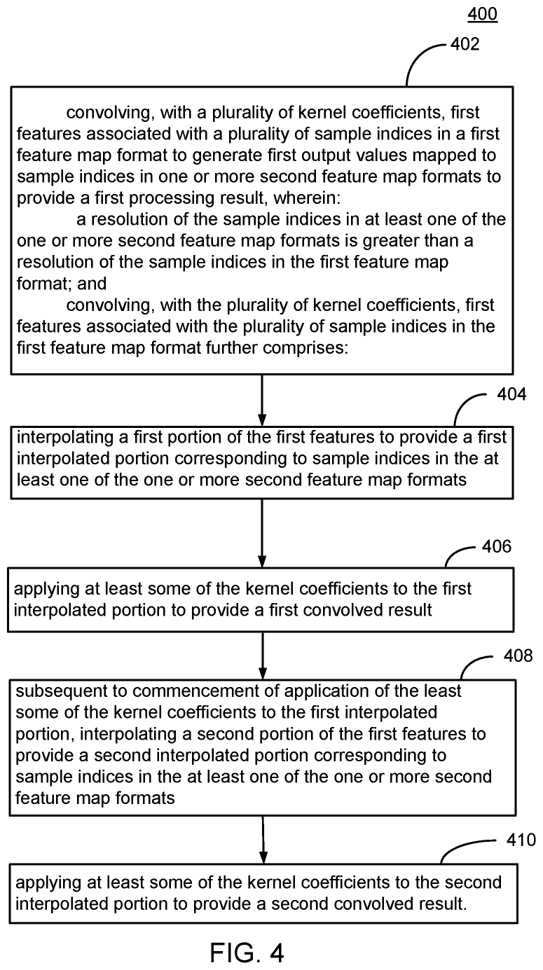

FIG. 4 is a flow diagram of a process 400 to apply a convolution operation to features of a feature map, according to an embodiment. In this context, a “feature map” as referred to herein means a mapping of features and/or values representing features according to a feature space. In one embodiment, a feature map may comprise an image frame defining one or more image signal intensity values (e.g., corresponding to different color channels) corresponding to pixel locations in the image frame. In another embodiment, a feature map may comprise one or more tensors having values computed as an intermediate computing result and/or output tensor of a neural network. It should be understood, however, that these are merely examples of a feature map, and claimed subject matter is not limited in this respect.

In one particular implementation, a feature map may be formatted, at least in part, by feature values associated with “sample indices.” Such sample indices may at least in part define a feature space along spatial dimensions. In a feature map comprising an image frame, for example, such sample indices along spatial dimensions may define pixel locations. In another implementation, such sample indices may at least in part define a feature space along one or more temporal dimensions. In one example, such sample indices along a temporal dimension may comprise a frame number in a temporal sequence of image frames. In another example, such sample indices along a temporal dimension may comprise sample intervals of a temporally sampled audio signal. It should be understood, however, that these are merely examples of sample indices that may define a feature space of a feature map, and claimed subject matter is not limited in this respect.

Block 402 may comprise a convolution operation according to expression (2) applied to feature values associated with sample indices in a first feature map format to generate first output values mapped to sample indices in one or more second feature map formats. In a particular implementation, sample indices in at least one of the second feature map formats may have a higher/greater resolution than a resolution of sample indices in the first feature map format.

In an embodiment, a first interpolated portion of the first features of may be computed at block 404 using any one of several interpolation techniques as discussed above. Such a first interpolated portion may comprise a mapping of feature values of a component and/or channel in a reduced resolution (e.g., L0 or L1) to sample indices of a component and/or channel in a full resolution (e.g., F0, F1, F2 or F3). In a particular implementation, such a first interpolated portion may comprise values

$${X}_{reduced}^{int} ( B , {map}_{reduced} ( k ) , \frac{y \times {H}_{reduced}}{{H}_{full}} + oy , \frac{x \times {W}_{reduced}}{{W}_{full}} + ox )$$

at sample indices

$$\frac{y \times {H}_{reduced}}{{H}_{full}} + oy , \frac{x \times {W}_{reduced}}{{W}_{full}} + ox$$

of a second (full resolution) feature map format. Block 408 may comprise applying at least some kernel coefficients (e.g., W(Cₒᵤₜ,k)) to the first interpolated portion to compute an output result (e.g., Out(B,Cₒᵤₜ,x,y)) corresponding with sample indices (e.g., x,y) according to the second (full resolution) feature map format.

Subsequent to commencement of application of kernel coefficients at block 406, block 408 may comprise interpolating a second portion of feature values associated with sample indices in a first feature map format to provide a second interpolated portion corresponding to the sample indices in a second feature map format. Block 410 may comprise applying the kernel coefficients to the second interpolated portion provided in block 408 to provide a second convolved result.

As may be observed from the particular example implementation according to expression (2), interpolated values

$${X}_{reduced}^{int} ( B , {map}_{reduced} ( k ) , \frac{y \times {H}_{reduced}}{{H}_{full}} + oy , \frac{x \times {W}_{reduced}}{{W}_{full}} + ox )$$

at sample indices

$$\frac{y \times {H}_{reduced}}{{H}_{full}} + oy , \frac{x \times {W}_{reduced}}{{W}_{full}} + ox$$

of the first interpolated portion need not be stored (e.g., in a memory) following application of kernel coefficients at block 404 to compute an output result. As pointed out above, in some examples, an order of interpolation and application of coefficients can be swapped. Approaching convolution operations in the context of multi-scale convolution may nonetheless allow similar benefits compared to full feature map interpolations prior to an addition operation.

According to an embodiment, all or portions of process 400 may be implemented according to an intermediate representation defined in a compiler. In one particular implementation, interpolation of the second portion of the first features to provide the second interpolated portion corresponding to sample indices in the at least one of the one or more second feature map formats subsequent to commencement of application of at least some of the kernel coefficients to the first interpolated portion at block 408; and the application of the at least some of the kernel coefficients to the second interpolated portion to provide the second convolved result at block 410 may be executed according to an intermediate representation defined in a compiler. Such an intermediate representation may include, for example, a multi-level intermediate representation (MLIR). In another particular implementation, interpolation of the second portion of the first features to provide the second interpolated portion corresponding to sample indices in the at least one of the one or more second feature map formats subsequent to commencement of application of at least some of the kernel coefficients to the first interpolated portion at block 408; and the application of the at least some of the kernel coefficients to the second interpolated portion to provide the second convolved result at block 410 may be executed according to a single operator defined in an MLIR compiler dialect. Such a single operator may be implemented in a machine code image in an optimization process executed by the MLIR compiler responsive to detection of a combination of instructions (e.g., in a source code image).

According to an embodiment system 100 and/or a device to execute any of expressions (2) through (5) may be formed by and/or expressed in transistors and/or lower metal interconnects (not shown) in processes (e.g., front end-of-line and/or back-end-of-line processes) such as processes to form complementary metal oxide semiconductor (CMOS) circuitry, just as an example. It should be understood, however, that this is merely an example of how circuitry may be formed in a device in a front end-of-line process, and claimed subject matter is not limited in this respect.

It should be noted that the various circuits disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

If received within a computer system via one or more machine-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process (e.g., wafer fabrication process).

In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

For one or more embodiments, systems described herein may be implemented in a device, such as a computing device and/or networking device, that may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, in-vehicle electronics or advanced driver-assistance systems (ADAS), or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

In the context of the present patent application, the term “connection,” the term “component” and/or similar terms are intended to be physical but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “coefficients” (e.g., one or more coefficients), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

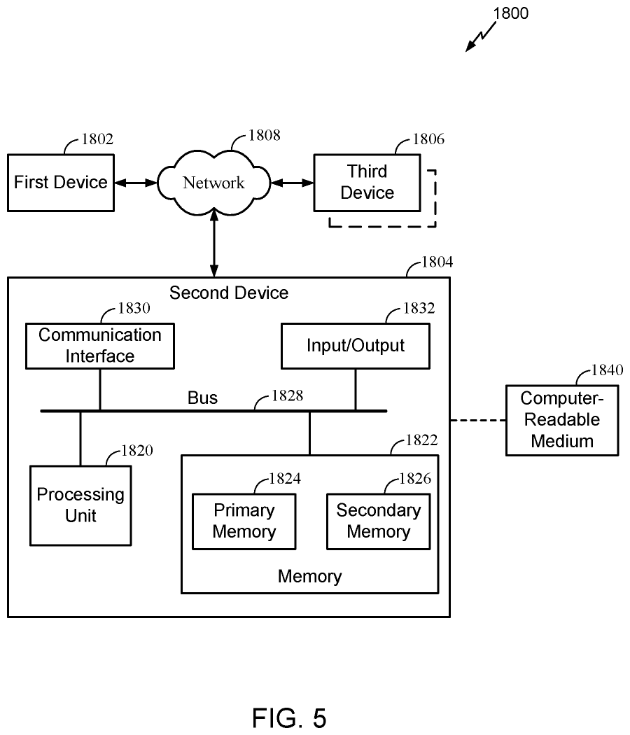

In one example embodiment, as shown in FIG. 5, a system embodiment may comprise a local network (e.g., device 1804 and medium 1840) and/or another type of network, such as a computing and/or communications network. For purposes of illustration, therefore, FIG. 5 shows an embodiment 1800 of a system that may be employed to implement either type or both types of networks. Network 1808 may comprise one or more network connections, links, processes, services, applications, and/or resources to facilitate and/or support communications, such as an exchange of communication signals, for example, between a computing device, such as 1802, and another computing device, such as 1806, which may, for example, comprise one or more client computing devices and/or one or more server computing device. By way of example, but not limitation, network 1808 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 5 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural network processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in expressions (2) through (5), FIG. 4 and in the text associated with the foregoing figure(s) of the present patent application.

Referring now to FIG. 5, in an embodiment, first and third devices 1802 and 1806 may be capable of rendering a graphical user interface (GUI) for a network device and/or a computing device, for example, so that a user-operator may engage in system use. Device 1804 may potentially serve a similar function in this illustration. Likewise, in FIG. 5, computing device 1802 (‘first device’ in figure) may interface with computing device 1804 (‘second device’ in figure), which may, for example, also comprise features of a client computing device and/or a server computing device, in an embodiment. Processor (e.g., processing device) 1820 and memory 1822, which may comprise primary memory 1824 and secondary memory 1826, may communicate by way of a communication bus 1815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 1804, as depicted in FIG. 5, is merely one example, and claimed subject matter is not limited in scope to this particular example. FIG. 5 may further comprise a communication interface 1830 which may comprise circuitry and/or devices to facilitate transmission of messages between second device 1804 and first device 1802 and/or third device 1806 in a physical transmission medium over network 1808 using one or more network communication techniques identified herein, for example. In a particular implementation, communication interface 1830 may comprise a transmitter device including devices and/or circuitry to modulate a physical signal in physical transmission medium according to a particular communication format based, at least in part, on a message that is intended for receipt by one or more recipient devices. Similarly, communication interface 1830 may comprise a receiver device comprising devices and/or circuitry demodulate a physical signal in a physical transmission medium to, at least in part, recover at least a portion of a message used to modulate the physical signal according to a particular communication format. In a particular implementation, communication interface may comprise a transceiver device having circuitry to implement a receiver device and transmitter device.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, and/or a display with a higher degree of functionality, such as a touch-sensitive color 5D or 3D display, for example.

In FIG. 5, computing device 1802 may provide one or more sources of executable computer instructions in the form physical states and/or signals (e.g., stored in memory states), for example. Computing device 1802 may communicate with computing device 1804 by way of a network connection, such as via network 1808, for example. As previously mentioned, a connection, while physical, may not necessarily be tangible. Although computing device 1804 of FIG. 5 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1822 may comprise any non-transitory storage mechanism. Memory 1822 may comprise, for example, primary memory 1824 and secondary memory 1826, additional memory circuits, mechanisms, or combinations thereof may be used. Memory 1822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 1822 may be utilized to store a program of executable computer instructions. For example, processor 1820 may fetch executable instructions from memory and proceed to execute the fetched instructions. Memory 1822 may also comprise a memory controller for accessing device readable-medium 1840 that may carry and/or make accessible digital content, which may include code, and/or instructions, for example, executable by processor 1820 and/or some other device, such as a controller, as one example, capable of executing computer instructions, for example. Under direction of processor 1820, a non-transitory memory, such as memory cells storing physical states (e.g., memory states), comprising, for example, a program of executable computer instructions, may be executed by processor 1820 and able to generate signals to be communicated via a network, for example, as previously described. Generated signals may also be stored in memory, also previously suggested.

Memory 1822 may store electronic files and/or electronic documents, such as relating to one or more users, and may also comprise a computer-readable medium that may carry and/or make accessible content, including code and/or instructions, for example, executable by processor 1820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, samples, observations, weights, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 5, processor 1820 may comprise one or more circuits, such as digital circuits, to perform at least a portion of a computing procedure and/or process. By way of example, but not limitation, processor 1820 may comprise one or more processors, such as controllers, microprocessors, microcontrollers, application specific integrated circuits, digital signal processors (DSPs), graphics processing units (GPUs), neural network processing units (NPUs), image signal processors (ISPs), programmable logic devices, field programmable gate arrays, the like, or any combination thereof. In various implementations and/or embodiments, processor 1820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 5 also illustrates device 1804 as including a component 1832 operable with input/output devices, for example, so that signals and/or states may be appropriately communicated between devices, such as device 1804 and an input device and/or device 1804 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In one embodiment disclosed herein, an article comprises: a storage medium comprising computer-readable instructions stored thereon that are executable by one or more processors of a computing device to: convolve, with a plurality of kernel coefficients, first features associated with a plurality of sample indices in a first feature map format to generate first output values mapped to sample indices in one or more second feature map formats to provide a first processing result, wherein: a resolution of the sample indices in at least one of the one or more second feature map formats is greater than a resolution of the sample indices in the first feature map format; and convolution, with the plurality of kernel coefficients, first features associated with the plurality of sample indices in the first feature map format further comprises: interpolation of a first portion of the first features to provide a first interpolated portion corresponding to sample indices in the at least one of the one or more second feature map formats; application of at least some of the kernel coefficients to the first interpolated portion to provide a first convolved result; subsequent to commencement of application of the least some of the kernel coefficients to the first interpolated portion, interpolation of a second portion of the first features to provide a second interpolated portion corresponding to sample indices in the at least one of the one or more second feature map formats; and application of at least some of the kernel coefficients to the second interpolated portion to provide a second convolved result. In one particular implementation, the one or more processors are further to: convolve, with the plurality of kernel coefficients, second features associated with a plurality of sample indices in the at least one of the one or more second feature map formats to provide a second processing result to comprise second output values mapped to sample indices in the at least one of the one or more second feature map formats. For example, the one or more processors may further combine the first processing result and the second processing result based, at least in part, on an association of first output values in the first processing result and second output values in the second processing result according to sample indices defined in the at least one of the one or more second feature map formats. In another particular implementation, convolution, with the plurality of kernel coefficients, image signal intensity values associated with one or more pixel locations in the first feature map format further comprises: interpolation between and/or among the image signal intensity values associated with the one or more pixel locations in the first feature map format to provide image signal intensity values mapped to the pixel locations in the at least one of the one or more second feature map formats; and application of the plurality of kernel coefficients to the image signal intensity values mapped to the pixel locations in the at least one of the one or more second feature map formats. In another particular implementation, convolution, with the plurality of kernel coefficients, first image signal intensity values associated with one or more pixel locations in the first feature map format further comprises: interpolation between and/or among image signal intensity values a first plurality of the first image signal intensity values to provide first interpolated image signal intensity values mapped to pixel locations of the at least one of the one or more second feature map formats; application of the plurality of kernel coefficients to the first interpolated image signal intensity values to compute a first output image signal intensity value associated with a first pixel location in the at least one of the one or more second feature map formats; and subsequent to computation of the first output image signal intensity value: interpolation between and/or among image signal intensity values a second plurality of the first image signal intensity values to provide second interpolated image signal intensity values mapped to pixel locations of the at least one of the one or more second feature map formats; and application of the plurality of kernel coefficients to the second interpolated image signal intensity values to compute a second output image signal intensity value associated with a second pixel location in the at least one of the one or more second feature map formats. In another particular implementation, convolution, with the plurality of kernel coefficients, image signal intensity values associated with one or more pixel locations in the first feature map format further comprises: selection of the plurality of pixel locations in the first feature map format based, at least in part, on the resolution of the first feature map format relative to the resolution of the at least one of the one or more second feature map formats. In another particular implementation, the first features are obtained from a first channel of multiple channels of a first feature map; and convolution of the first features associated with the plurality of sample indices in the first feature map further comprises combination of the first features with second features obtained from a channel of multiple channels of a second feature map to provide the first convolved result.

In another embodiment disclosed herein, an apparatus comprises: a memory storage device; and one or more processors coupled to the memory storage device, the one or more processors to: convolve, with a plurality of kernel coefficients, first features of a first feature map associated with a first plurality of sample indices in a first feature map format to generate a plurality of first output values mapped to sample indices in the first feature map format; interpolate the first output values to provide first interpolated values of a second feature map mapped to first sample indices in one or more second feature map formats; and subsequent to commencement of interpolation of the first output values to provide the first interpolated values, convolve, with the plurality of kernel coefficients, second features of the first feature map associated with a second plurality of sample indices in the first feature map format to generate a plurality of second output values mapped to sample indices in the first feature format. In one particular implementation, the first features of the first feature map comprise image signal intensity values associated with first pixel locations of an image frame and the second features of the first feature map comprise image signal intensity values associated with second pixel locations of the image frame. In another particular implementation, the one or more processors are further to: interpolate the second output values to second sample indices in the one or more second feature map formats.

In another embodiment disclosed herein, an article comprises: a non-transitory storage medium comprising computer readable instructions stored thereon which are executable by one or more processors to: convolve, with a plurality of kernel coefficients, first features of a first feature map associated with a first plurality of sample indices in a first feature map format to generate a plurality of first output values mapped to sample indices in the first feature map format; interpolate the first output values to provide first interpolated values of a second feature map mapped to first sample indices in one or more second feature map formats; and subsequent to commencement of interpolation of the first output values to provide the first interpolated values, convolve, with the plurality of kernel coefficients, second features of the first feature map associated with a second plurality of sample indices in the first feature map format to generate a plurality of second output values mapped to sample indices in the first feature format. In one particular implementation, the first features of the first feature map comprise image signal intensity values associated with first pixel locations of an image frame and the second features of the first feature map comprise image signal intensity values associated with second pixel locations of the image frame. In another particular implementation, the instructions are further executable by the one or more processors to: interpolate the second output values to second sample indices in the one or more second feature map formats.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
convolving, with a plurality of kernel coefficients, first features associated with a plurality of sample indices in a first feature map format to generate first output values mapped to sample indices in one or more second feature map formats to provide a first processing result, wherein:
a resolution of the sample indices in at least one of the one or more second feature map formats is greater than a resolution of the sample indices in the first feature map format; and
convolving, with the plurality of kernel coefficients, first features associated with the plurality of sample indices in the first feature map format further comprises:
interpolating a first portion of the first features to provide a first interpolated portion corresponding to sample indices in the at least one of the one or more second feature map formats;
applying at least some of the kernel coefficients to the first interpolated portion to provide a first convolved result;
subsequent to commencement of application of the least some of the kernel coefficients to the first interpolated portion, interpolating a second portion of the first features to provide a second interpolated portion corresponding to sample indices in the at least one of the one or more second feature map formats; and
applying at least some of the kernel coefficients to the second interpolated portion to provide a second convolved result.

2. The method of claim 1, wherein
interpolation of the second portion of the first features to provide the second interpolated portion corresponding to sample indices in the at least one of the one or more second feature map formats subsequent to commencement of application of at least some of the kernel coefficients to the first interpolated portion; and
the application of the at least some of the kernel coefficients to the second interpolated portion to provide the second convolved result are executed according to an intermediate representation defined in a compiler.

3. The method of claim 2, wherein the intermediate representation comprises a multi-level intermediate representation (MLIR) comprising multi-scale convolution as an executable operation.

4. The method of claim 1, wherein
interpolation of the second portion of the first features to provide the second interpolated portion corresponding to sample indices in the at least one of the one or more second feature map formats subsequent to commencement of application of at least some of the kernel coefficients to the first interpolated portion; and
the application of the at least some of the kernel coefficients to the second interpolated portion to provide the second convolved result are executed according to a single operator defined in an multi-level intermediate representation (MLIR) compiler dialect.

5. The method of claim 4, wherein the single operator is implemented in a machine code image in an optimization process executed by the MLIR compiler responsive to detection of a combination of instructions.

6. The method of claim 1, and further comprising:
convolving, with the plurality of kernel coefficients, second features associated with a plurality of sample indices in the at least one of the one or more second feature map formats to provide a second processing result comprising second output values mapped to sample indices in the at least one of the one or more second feature map formats.

7. The method of claim 6, and further comprising combining the first processing result and the second processing result at least in part, by associating first output values in the first processing result and second output values in the second processing result according to sample indices defined in the at least one of the one or more second feature map formats.

8. The method of claim 1, wherein convolving, with the plurality of kernel coefficients, image signal intensity values associated with one or more pixel locations in the first feature map format further comprises:
interpolating between and/or among the image signal intensity values associated with the one or more pixel locations in the first feature map format to provide image signal intensity values mapped to the pixel locations in the at least one of the one or more second feature map formats; and
applying the plurality of kernel coefficients to the image signal intensity values mapped to the pixel locations in the at least one of the one or more second feature map formats.

9. The method of claim 1, wherein convolving, with the plurality of kernel coefficients, first image signal intensity values associated with one or more pixel locations in the first feature map format further comprises:
interpolating between and/or among image signal intensity values a first plurality of the first image signal intensity values to provide first interpolated image signal intensity values mapped to pixel locations of the at least one of the one or more second feature map formats;
applying the plurality of kernel coefficients to the first interpolated image signal intensity values to compute a first output image signal intensity value associated with a first pixel location in the at least one of the one or more second feature map formats; and
subsequent to computation of the first output image signal intensity value:
interpolating between and/or among image signal intensity values a second plurality of the first image signal intensity values to provide second interpolated image signal intensity values mapped to pixel locations of the at least one of the one or more second feature map formats; and
applying the plurality of kernel coefficients to the second interpolated image signal intensity values to compute a second output image signal intensity value associated with a second pixel location in the at least one of the one or more second feature map formats.

10. The method of claim 1, wherein convolving, with the plurality of kernel coefficients, image signal intensity values associated with one or more pixel locations in the first feature map format further comprises:
selecting the one or more pixel locations in the first feature map format based, at least in part, on the resolution of the first feature map format relative to the resolution of the at least one of the one or more second feature map formats.

11. The method of claim 1, wherein:
the first features are obtained from a first channel of multiple channels of a first feature map; and
convolving the first features associated with the plurality of sample indices in the first feature map further comprises combining the first features with second features obtained from a channel of multiple channels of a second feature map to provide the first convolved result.

12. An apparatus comprising:
a memory storage device; and
one or more processors coupled to the memory storage device, the one or more processors to:
convolve, with a plurality of kernel coefficients, first features associated with a plurality of sample indices in a first feature map format to generate first output values mapped to sample indices in one or more second feature map formats to provide a first processing result, wherein:
a resolution of the sample indices in at least one of the one or more second feature map formats is greater than a resolution of the sample indices in the first feature map format; and
convolution, with the plurality of kernel coefficients, first features associated with the plurality of sample indices in the first feature map format further comprises:
interpolation of a first portion of the first features to provide a first interpolated portion corresponding to sample indices in the at least one of the one or more second feature map formats;
application of at least some of the kernel coefficients to the first interpolated portion to provide a first convolved result;
subsequent to commencement of application of the least some of the kernel coefficients to the first interpolated portion, interpolation of a second portion of the first features to provide a second interpolated portion corresponding to sample indices in the at least one of the one or more second feature map formats; and
application of at least some of the kernel coefficients to the second interpolated portion to provide a second convolved result.

13. The apparatus of claim 12, wherein the one or more processors are further to:
convolve, with the plurality of kernel coefficients, second features associated with a plurality of sample indices in the at least one of the one or more second feature map formats to provide a second processing result to comprise second output values mapped to sample indices in the at least one of the one or more second feature map formats.

14. The apparatus of claim 12, wherein convolution, with the plurality of kernel coefficients, image signal intensity values associated with one or more pixel locations in the first feature map format further comprises:
interpolation between and/or among the image signal intensity values associated with the one or more pixel locations in the first feature map format to provide image signal intensity values mapped to the pixel locations in the at least one of the one or more second feature map formats; and
application of the plurality of kernel coefficients to the image signal intensity values mapped to the pixel locations in the at least one of the one or more second feature map formats.

15. The apparatus of claim 12, wherein convolution, with the plurality of kernel coefficients, first image signal intensity values associated with one or more pixel locations in the first feature map format further comprises:
interpolation between and/or among image signal intensity values a first plurality of the first image signal intensity values to provide first interpolated image signal intensity values mapped to pixel locations of the at least one of the one or more second feature map formats;
application of the plurality of kernel coefficients to the first interpolated image signal intensity values to compute a first output image signal intensity value associated with a first pixel location in the at least one of the one or more second feature map formats; and
subsequent to computation of the first output image signal intensity value:
interpolation between and/or among image signal intensity values a second plurality of the first image signal intensity values to provide second interpolated image signal intensity values mapped to pixel locations of the at least one of the one or more second feature map formats; and
application of the one or more kernel coefficients to the second interpolated image signal intensity values to compute a second output image signal intensity value associated with a second pixel location in the at least one of the one or more second feature map formats.

16. The apparatus of claim 12, wherein convolution, with the plurality of kernel coefficients, image signal intensity values associated with one or more pixel locations in the first feature map format further comprises:
selection of the plurality of pixel locations in the first feature map format based, at least in part, on the resolution of the first feature map format relative to the resolution of the at least one of the one or more second feature map formats.

17. The apparatus of claim 12, wherein:
the first features are obtained from a first channel of multiple channels of a first feature map; and
convolution of the first features associated with the plurality of sample indices in the first feature map further comprises combination of the first features with second features obtained from a channel of multiple channels of a second feature map to provide the first convolved result.

18. A method comprising:
convolving, with a plurality of kernel coefficients, first features of a first feature map associated with a first plurality of sample indices in a first feature map format to generate a plurality of first output values mapped to sample indices in the first feature map format;
interpolating the first output values to provide first interpolated values of a second feature map mapped to first sample indices in one or more second feature map formats; and
subsequent to commencement of interpolation of the first output values to provide the first interpolated values, convolving, with the plurality of kernel coefficients, second features of the first feature map associated with a second plurality of sample indices in the first feature map format to generate a plurality of second output values mapped to sample indices in the first feature map format.

19. The method of claim 18, wherein the first features of the first feature map comprise image signal intensity values associated with first pixel locations of an image frame and the second features of the first feature map comprise image signal intensity values associated with second pixel locations of the image frame.

20. The method of claim 18, and further comprising:
interpolating the second output values to second sample indices in the one or more second feature map formats.
